(19) United States
(12) Patent Application Publication
(10) Pub. No.: US 2011/0294963 A1
(43) Pub. Date: Dec. 1, 2011

(54) METHOD OF TOUGHENING EPOXY RESIN AND TOUGHENED EPOXY RESIN COMPOSITE

(75) Inventors: HSU-CHIANG KUAN, Kaohsiung City (TW); CHEN-FENG KUAN, Taichung County (TW); HSIN-CHIN PENG, Taichung City (TW); CHIA-HSUN CHEN, Taichung City (TW); KUN-CHANG LIN, Tainan City (TW); MIN-CHI CHUNG, Taichung County (TW); YU-CHUEN LO, Tainan County (TW); JHEN-CHENG WANG, Tainan County (TW); CHIN-YING WANG, Tainan County (TW); CHIN-LUNG CHIANG, Changhua County (TW)

(73) Assignee: FAR EAST UNIVERSITY, Tainan County (TW)

(21) Appl. No.: 12/788,333

(22) Filed: May 27, 2010

(51) Int. Cl. C08L 63/00

(52) U.S. Cl. 525/452

(57) ABSTRACT

The present invention discloses a novel toughener selected from the group of polyurea, polyurethane and poly(urea-urethane) using a facile synthesis method. The toughener forms thick-interface particles, and creates an effective toughness improvement for epoxy resin. Different from the conventional epoxy/rubber composite or epoxy/thermoplastic composite, the epoxy/polyurea, epoxy/polyurethane, or epoxy/poly(urea-urethane) composite shows Newtonian rheological behaviour, a convenient property for processing. The unique feature of the toughener according to the present invention is that toughness can be significantly improved at low toughener content without losing other desirable properties.

### FIELD OF THE INVENTION

The present invention relates to epoxy resin, and in particular to a method of toughening epoxy resin and a toughened epoxy resin composite

### BACKGROUND

Epoxy resins are highly crosslinked polymers, which have high stiffness, high strength and good solvent resistance. These properties make epoxy resins widely applicable industrially for surface coatings, adhesives, painting materials, composites, laminates, encapsulants for semiconductors, insulating materials for electric devices, and so on. However, the high crosslink density makes epoxy resins inherently brittle, leading to poor resistance to crack propagation, that is, epoxy resins are vulnerable to the presence of microcracks which are caused by the mismatch of thermal expansion coefficients between epoxy resins and their surrounding environment or bonded parts. This can cause catastrophic disaster. Therefore, much effort has been made to improve the fracture toughness of epoxy resins.

One effective approach is the addition of second-phase polymers, such as rubbers and thermoplastics. Rubber-toughened epoxy resins are made by mechanically mixing liquid rubber and epoxy resins to obtain a homogeneous solution. During curing, rubber molecules' aggregate to form micrometre-sized particles (1-10 μm in diameter) as the second phase. Significant fracture toughness improvement has been observed with a rubber content of 10-20 wt %, which unfortunately has a penalty of loss of stiffness, i.e. 27% modulus loss with 15 wt % rubber compounded into diglycidyl ether of bisphenol-A (DGEBA). To address this disadvantage, rigid thermoplastics have been developed. In a typical procedure, a thermoplastic is dissolved in an epoxy resin. It then separates during curing through nucleation and growth to form micrometre-sized particles or a co-continuous structure. Significant toughness improvement cannot be achieved unless a co-continuous structure is formed, which unfortunately results in loss of other desirable properties such as solvent resistance. In conclusion, both rubber- and thermoplastic-toughening methods form micrometre-scale structures, and a satisfactory toughness improvement requires a substantial toughener of 10-20 wt %. Because of the high toughener content, the toughness improvement is accompanied by sacrificing other desirable properties. It is worth noting that a reactive toughening agent containing flexible spacers and rigid liquid crystalline units is developed, which improved impact strength more than three times without deterioration of modulus and thermal properties.

Recently, two types of new materials are reported to toughen epoxy resins without or with little modulus loss. Wherein, one type is nanocomposites including nanoclay, nanorubber, nanosilica, and nanotube. As expected, 5-10 wt % high modulus inorganic nanoparticles increase significantly the Young's modulus but not the fracture toughness of epoxy resins. The other one type is block copolymers, not pure rubber, as effective particles to toughen brittle polymers with little loss of stiffness. These block copolymers form self-organized nanostructures during mixing, which are finally fixed through subsequent curing after hardeners are added. Noteworthy is that a reactive block copolymer is developed to enhance interface adhesion. However, the high production cost of these materials limits their applications.

### SUMMARY

In view of the aforementioned drawbacks, an object of the present invention is to develop a novel toughener capable of effectively toughening an epoxy resin with low production cost.

According to the object of the present invention, a method of toughening epoxy resin is provided, comprising a step of mixing an epoxy resin with a toughener selected from the group consisting of polyurea, polyurethane and poly(urea-urethane) for a predetermined period of time at a predetermined temperature. Wherein, an amine group of the toughener is reacted with an epoxide group of the epoxy resin, or an isocyanate group of the toughener is reacted with a hydroxyl group of the epoxy resin to form a modified epoxy resin. Optionally, the method of toughening epoxy resin further comprises a step of adding a hardener to cure the epoxy resin.

Preferably, the polyurea is synthesized by a stepwise addition polymerization reaction of diamines and diisocyanates, and may have weight-average molecular weight in a range of 200 to 60000. The diamines comprises polyoxyalkyleneamine, and the diisocyanates comprises diphenylmethane diisocyanate (MDI), toluene diisocyanate (TDI), hexamethylene diisocyanate (HDI) or isophorone diisocyanate (IPDI). The epoxy resin comprises diglycidyl ether of bisphenal A (DGEBA) or diglycidyl ether of bisphenal F (DGEBF). The predetermined period of time is preferably in a range of about 1 to about 60 minutes.

A toughened epoxy resin composite is further provided, comprising an epoxy resin and a toughener selected from the group consisting of polyurea, polyurethane and poly(urea-urethane). Optionally, the toughened epoxy resin composite further comprises a hardener. Preferably, the hardener may be present in an amount of about 5-25% by weight.

The method of toughening epoxy resin and the toughened epoxy resin composite according to the present invention may have one or more advantages as follows:

(1) The novel toughener in accordance with the present invention increases the particle weight fraction, thus improving the toughness of the epoxy resin, and it acts as a compatibiliser, improving the interfacial adhesion.

(2) The unique feature of the present invention is that toughness can be significantly improved at low toughener content without losing other desirable properties. Besides, the present invention illuminates the importance of the interface for toughening in polymer blends/composites.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic diagram of a diamine oligomer/IPDI reaction in accordance with the present invention;

FIG. 2 illustrates an SEM micrograph of an epoxy/polyurea-1 composite in accordance with the present invention;

FIG. 3 illustrates TEM micrographs of the epoxy/polyurea-1 composite in accordance with the present invention;

FIG. 4 illustrates an effect of the polyurea-1 content on modulus and tensile strength in accordance with the present invention;

FIG. 5 illustrates an effect of the polyurea-1 content on fracture toughness and energy release rate in accordance with the present invention;

FIG. 6 illustrates SEM micrographs of fractured CT specimen of neat epoxy, with crack propagating from left to right in accordance with the present invention;

FIG. 7 illustrates SEM micrographs of fractured CT specimen of the epoxy/polyurea-1 composite, with crack propagating from lift to right in accordance with the present invention;

FIG. 8 illustrates dependence of shear stress on shear rate for the neat epoxy and the epoxy/polyurea-1 composite in accordance with the present invention;

FIG. 9 illustrates TEM micrographs of an epoxy/polyurea-2 composite in accordance with the present invention;

FIG. 10 illustrates an effect of the polyurea-2 content on modulus and tensile strength in accordance with the present invention;

FIG. 11 illustrates an effect of the polyurea-2 content on fracture toughness and energy release rate in accordance with the present invention;

FIG. 12 illustrates SEM micrographs of fractured CT specimen of the epoxy/polyurea-2 composite, with crack propagating from left to right in accordance with the present invention;

FIG. 13 illustrates DMTA plots of the neat epoxy, the epoxy/polyurea-1 composite, and the epoxy/polyurea-2 composite in accordance with the present invention;

FIG. 14 illustrates a molecular weight pattern of polyurea in accordance with the present invention;

FIG. 15 illustrates a schematic diagram of an exchange reaction of polyurea in accordance with the present invention;

FIG. 16 illustrates dependence of molecular weight on mixing time at 120° C. in accordance with the present invention;

FIG. 17 illustrates FT-IR spectrums of neat epoxy and an epoxy/polyurea composite solutions mixed for different time. in accordance with the present invention;

FIG. 18 illustrates schematic reactions: (a) epoxy molecules; (b) reaction of hydroxyl group with NCO group; (c) & (d) reactions of amine group with epoxide group in accordance with the present invention;

FIG. 19 illustrates TEM microphotographs of the epoxy/polyurea composite mixed for 5 minutes at 120° C. in accordance with the present invention;

FIG. 20 illustrates TEM microphotographs of the epoxy/polyurea composite mixed for 20 minutes at 120° C. in accordance with the present invention; and

FIG. 21 illustrates TEM microphotographs of the epoxy/polyurea composite mixed for 35 minutes at 120° C. in accordance with the present invention.

### DETAILED DESCRIPTION

Exemplary embodiments of the present invention are described herein in the context of the method of toughening epoxy resin and the toughened epoxy resin composite.

### Example 1

### Synthesis of Polyurea-I

Jeffamine D-2000 with M_{w} 2000 (polyoxyalkyleneamine; denoted Jeff-D2000, 26.2 g) and acetone (52.4 g) were charged into a 250 ml four-necked round-bottom flask and mechanically mixed for 5 minutes. Isophorone diisocyanate (IPDI, 2.97 g) was magnetically mixed with acetone (59.7 g) for 5 minutes. The molar ratio of the isocyanate group (—NCO) and the hydroxyl group (—OH) remained at 1.02. The IPDI solution was then added into the flask at a rate of one drop every 3 seconds, using a micro-pump at −5 to 0° C., and mixed for 10 minutes. This low-temperature reaction allowed the condensation to occur slowly producing polyurea with a relatively low molecular weight distribution. Tin(II)2-ethylhexanoate catalyst (0.2 g) was added to the flask. The temperature was then increased to 60° C. at 5° C./min, and the reaction mixed for 5 hours. The final polymer (i.e. polyurea-1) was transferred to a beaker which was sealed and stored at 0-5° C.

Synthesis of Polyurea-2

Jeffamine D-400 with M_{w} 400 (polyoxyalkyleneamine; denoted Jeff-D400, 7.446 g) and acetone (74.46 g) were charged into a 500 ml beaker and mechanically mixed for 5 minutes. IPDI (4.221 g) was magnetically mixed with acetone (42.21 g) for 5 minutes. The ratio of the isocyanate group (—NCO) and the hydroxyl group (—OH) remained at 1.02. The IPDI solution was added into the beaker at a rate of one drop every 3 seconds, using a micro-pump at room temperature, and then mixed for 10 minutes. The final polymer (i.e. polyurea-2) was transferred to a beaker which was sealed and stored at 0-5° C. The reaction scheme for the polyurea-2 is similar to that for the polyurea-1.

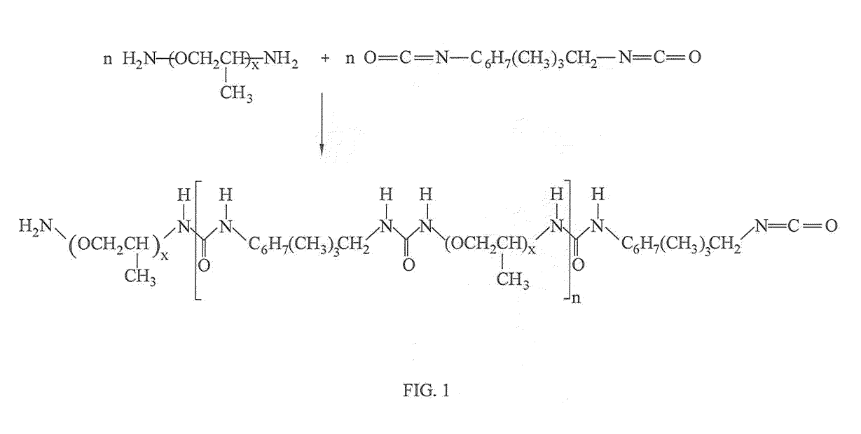

FIG. 1 shows a schematic diagram of a diamine oligomer/IPDI reaction. As shown in FIG. 1, the polyurea-1 (or polyurea-2) is prepared by the stepwise addition polymerization reaction of diamines and diisocyanates with the migration of a hydrogen atom. Because this polymerization does not involve elimination of small molecules such as water, high molecular weight can be readily achieved by controlling strict equivalence in the proportions of the starting reacting groups.

Each repeat unit of polyurea comprises flexible segments (polyoxyalkyleneamine,
Jeffamine series) and stiff segments (IPDI). As described above, the flexible-chain Jeff-D2000 and Jeff-D400 are structurally similar, but the former molecular chain is five times longer, as evidenced by the molecular weight difference. Therefore, polyurea synthesized with these two materials should exhibit different properties, and thus create different toughening effects. The effects of the two types of polyurea on themorphology, mechanical properties, fracture toughness and thermal properties of epoxy were investigated.

Synthesis of Epoxy/Polyurea Composites

The 1-10 wt %, preferably 5 wt %, polyurea-1 (or polyurea-2) was mechanically mixed with a desired amount of epoxy resin (Araldite LC191) with an epoxide equivalent weight of 208 g/eq. (denoted as epoxy), in a beaker at 80° C. for 20 minutes to evaporate the acetone. The temperature was then increased to 100° C. and mixing was continued for 30 minutes. When the mixture naturally cooled to 40° C., hardener (triethylenetetramine, 25 g for 100 g of epoxy) was added dropwise with mixing. After 2 minutes of mixing, the blend was degassed and poured into different moulds, followed by curing at 70° C. for 2 h.

Tensile and Fracture Toughness Tests

Tensile dumbbell specimens with a gauge length of 50 mm were made using a silicone rubber mould. Both sides were polished with an emery paper until all visible marks were removed. The specimens were then post-cured at 70° C. for 10 minutes. Tensile tests were performed at a strain rate of 0.5 mm/min at room temperature using a tensile machine. An extensometer was used to collect accurate displacement data to determine the elastic moduli.

Compact-tension (CT) specimens were prepared using a rubber mould and steel pins according to ISO 13 586 with specimen width (W) of ca 30 mm and thickness (B) of 5-6 mm. The CT specimens were cured in the mould and then both sides were polished with an emery paper until all visible marks disappeared. A sharp crack was introduced by razor tapping. Tapping a razor blade on a thermoset specimen initiates two types of cracks: non-propagated and instantly propagated cracks. Only the instantly propagated cracks are sufficiently sharp for valid fracture toughness measurements. Six specimens were tested for each data set with a crosshead speed of 0.5 mm/min. Fracture toughness K_{1c} and G_{1c} values of CT specimens were calculated using maximum loads and validated according to ISO 13 586.

Election Microscopy Analysis

SEM was used to examine the fracture surfaces of tested CT specimens, which were coated with a thin layer of gold and observed using a SEM instrument at an accelerating voltage 10 kV. Ultra-thin sections of 50-60 nm in thickness were cryogenically microtomed with a diamond knife in liquid nitrogen at −120° C. using a microtome. Sections were collected on 400-mesh copper grids and stained with the vapour of a 1 wt % ruthenium tetroxide (RuO₄) water solution for 8 minutes to enhance the phase contrast between particles and epoxy. Subsequently, thin sections were examined using a transmission electron microscopy (TEM) instrument at an accelerating voltage of 120 kV.

Dynamic Mechanical Analysis

Dynamic mechanical experiments were carried out at a frequency of 1 Hz using a dynamic mechanical analyser. A single cantilever clamp with a supporting span of 20.00 mm was used. Rectangular specimen with a thickness of 4 mm and width of 12 mm were tightened on the clamp using a torque of 1 N m. Specimens were scanned from 40 to 120° C. with data recorded at 2 seconds per point.

Results for Epoxy/Polyurea-1 Composite

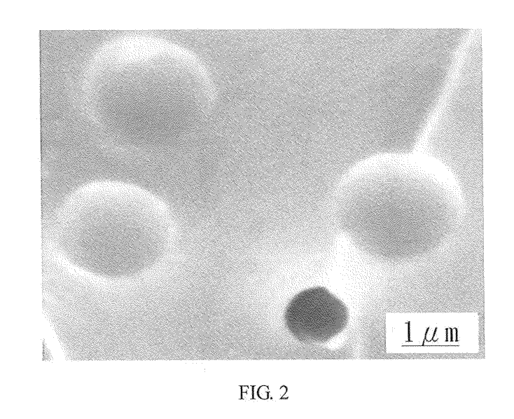

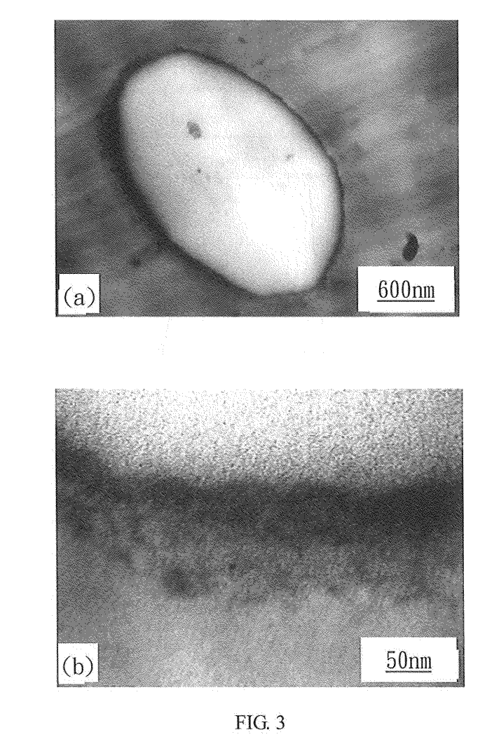

Morphology: FIG. 2 shows an SEM micrograph of the epoxy/polyurea-1 composite. Particles with a diameter of ca 2 μm are separately dispersed in the epoxy matrix. The formation of particles is similar to conventional epoxy/liquid rubber composites, in which epoxy and rubber are miscible before curing and rubber particulate phase is formed during curing. It is noteworthy that the interface between the rubber particles and matrix is thin and weak, as no interface thickness has been observed. However, the epoxy/polyurea-1 composite of the present invention is different in terms of interface thickness. FIG. 3 illustrates TEM micrographs of the epoxy/polyurea-1 composite. When a typical particle is observed with TEM (FIG. 3(a)), it displays a distinctive interface. A high-magnification image in FIG. 3(b) indicates a thickness of ca 100 nm. Two factors may explain the formation of the thick interface: the reaction between the amine group (—NH) of the polyurea-1 and the epoxide group of the matrix; and the reaction between the isocyanate group (—NCO) of the polyurea-1 and the hydroxyl group (—OH) of the matrix.

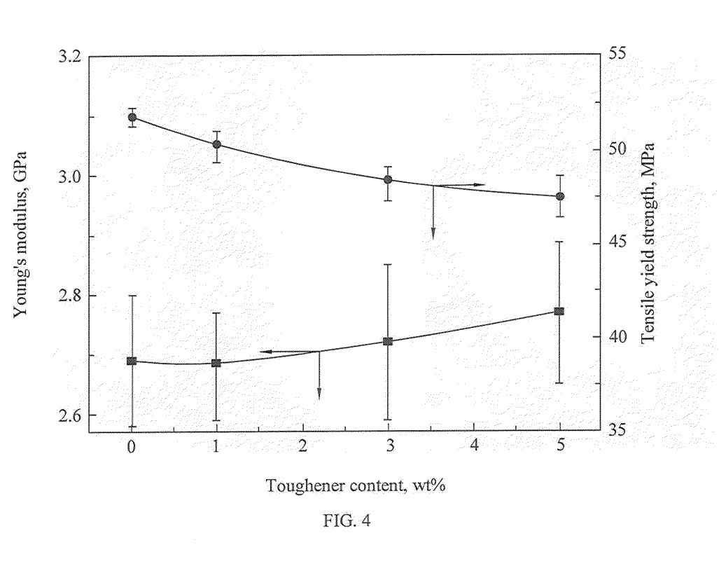

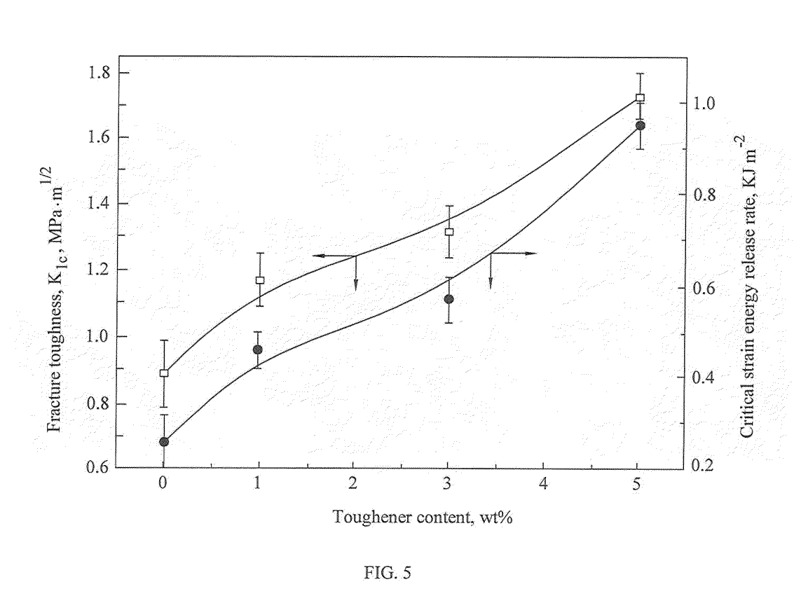

Mechanical properties and toughness: FIG. 4 shows the dependence of Young's modulus and tensile strength on the polyurea-1 content. While the tensile strength decreases marginally, the polyurea-1 causes no reduction of modulus. FIG. 5 illustrates an effect of the polyurea-1 content on fracture toughness and energy release rate. As shown in FIG. 5, fracture toughness increases linearly with polyurea content. It is well known that brittleness is the most serious problem affecting epoxy. Conventional tougheners cause loss of other desirable properties, such as modulus and solvent resistance. By contrast, the polyurea-1 demonstrates higher efficiency of toughening and, more importantly, this is achieved without deterioration of other properties.

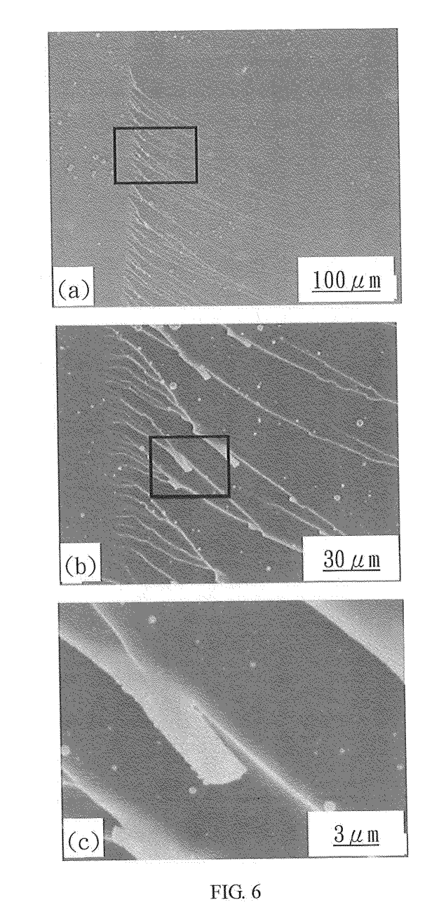

Fracture surface analysis by SEM: The surfaces of fractured CT specimens of neat epoxy and its composites were coated with gold and examined using SEM. FIG. 6 shows SEM micrographs of fractured CT specimen of neat epoxy, with crack propagating from left to right. In FIG. 6(a), only a few hackles of ca 500 μm in length are observed for neat epoxy. The rectangular zone in FIG. 6(a) is magnified in FIG. 6(b); it shows that these hackles originate either from the crack tip or from the propagation zone, and change directions upon joining other hackles. The rectangular zone in FIG. 6(b) is magnified in FIG. 6(c); it shows that bands of ca 3 μm in width can be seen, which originate during fracture. The formation of the bands consumes energy. The number and size of the hackles and the bands correspond to the relatively high fracture toughness of the neat epoxy resin, i.e. 0.260 kJ m⁻², in comparison with 0.07-0.20 kJ m² for other neat epoxy resins which show mirror-like fracture surface with fewer and smaller hackles.

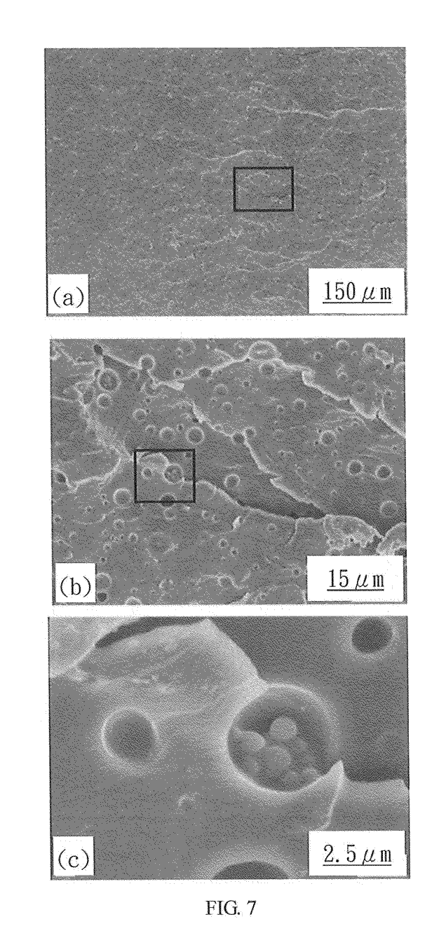

FIG. 7 shows SEM micrographs of the surface of a fractured CT specimen of the epoxy composite containing 5 wt % of the polyurea-1 (denoted as the epoxy/polyurea-1 composite), with crack propagating from left to right. The propagation zone in FIG. 7(a) shows a scale-like structure. A typical zone (marked by the rectangle) magnified in FIG. 7(b) confirms the structure with details of tortuous cracks and particles of 3-7 μm in diameter. While most particles are particulate and featureless, some particles show multiphase structure, one of which is further magnified in FIG. 7(c). The particle has a ‘salami’-type structure similar to that found in high-impact polystyrene.

Fracture toughness measures the energy consumption of a material in preventing crack propagation. Crack propagation originates from a crack tip where energy is dissipated by inelastic deformation. The deformation is triggered by the high stresses borne through the chains right at the crack tip. In comparison with single-phase structure, multi-phase structure can produce a higher level of inelastic deformation to resist crack propagation. In this embodiment, the polyurea-1 reacted with epoxy during mixing, leading to a strong interface of the particles to be formed during subsequent curing. As tensile strength slightly decreased upon compounding with the polyurea-1, the particle stiffness should be lower than that of the matrix. Under loading, the particles deform first and the surrounding matrix subsequently experiences void deformation and growth. These two types of deformation serve the following functions: (i) consuming energy and (ii) changing the crack propagation direction into multi-direction because of the multi-phase structure with strong interface. As a result, fracture toughness improves significantly.

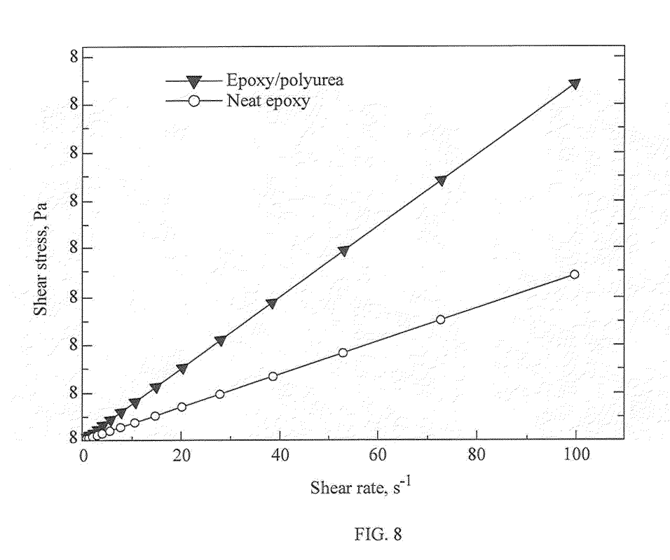

Rheology: Most polymeric materials exhibit viscoelasticity. A combination of the viscosity of a liquid and the elasticity of a solid. Compared to simple liquids, polymers are very different and have extremely high viscosity and a special flow characteristic, which shows a shear thinning (pseudoplastic) behaviour under shear stress. Here, the rheology of neat epoxy and the epoxy containing 5 wt % of the polyurea-1 after mixing for 30 minutes at 100° C. FIG. 8 shows the dependence of the shear stress on the shear rate for both materials. With increasing shear rate, the shear stresses of both materials increase linearly, indicating Newtonian liquid behaviour; for the same shear rate, the composite shows a higher shear stress rate. By contrast, a liquid rubber-modified epoxy shows much higher slope of stress rate and a shear-thinning (pseudoplastic) liquid behaviour, which are caused by 10-20 wt % of high-molecular weight rubber. This implies that epoxy/polyurea is a system that is convenient to process, an advantage over convention epoxy/liquid rubber.

Results of epoxy/polyurea-2 composite

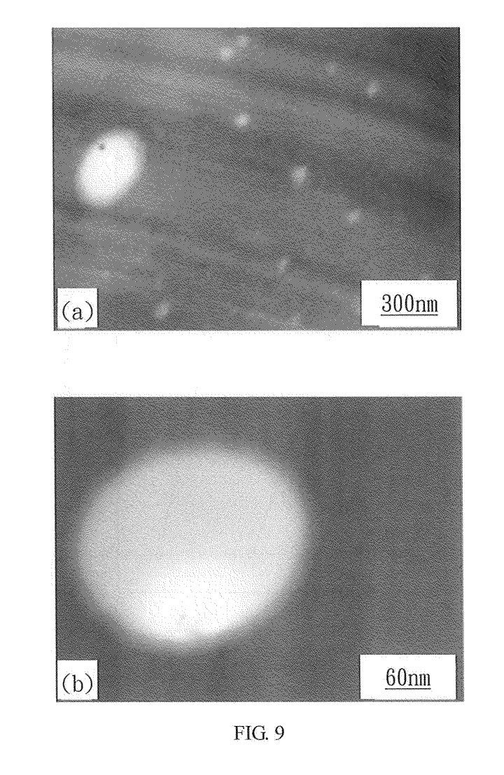

Morphology: FIG. 9 shows TEM micrographs of the epoxy/polyurea-2 composite. The microstructure of the epoxy/polyurea-2 composite shown in FIG. 9(a) comprises two types of particles: micrometre-sized particles of Ca 0.3 μm in diameter and nanoparticles with a diameter less than 100 nm. A typical micrometre-sized particle shown in FIG. 9(b) demonstrates a distinctive interface of 20 nm in thickness.

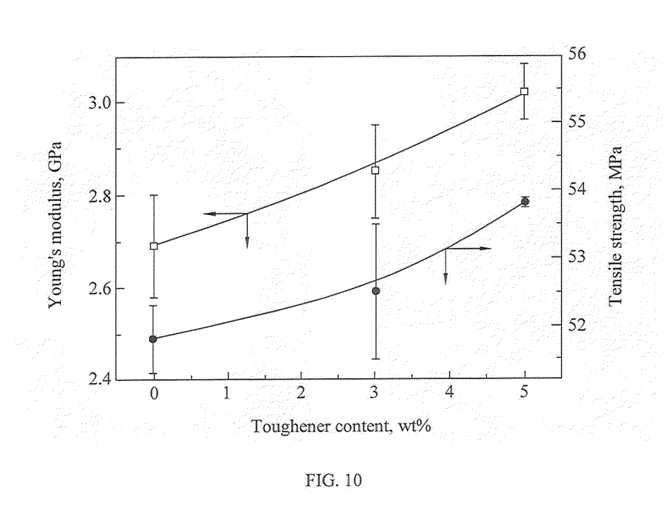

Mechanical properties and toughness: FIG. 10 shows an effect of the polyurea-2 content on modulus and tensile strength. As shown in FIG. 10, Young's modulus increases with toughener content. With 5 wt % of the polyurea-2, it improves 12%. This means the polyurea-2 is stiffer than the epoxy matrix. With increasing the polyurea-2 content, the tensile strength also improves by 4%. When brittle epoxy is toughened by a stiffer second-phase material, Young's modulus always increases. However, tensile strength may show a different trend, depending on the interface strength. In the case of a weak interface such as in epoxy toughened by clay, tensile strength decreases; in the case of a strong interface such as in epoxy/silica nanocomposites, tensile strength increases. In this embodiment, the epoxy/polyurea-2 composite demonstrate an increased tensile strength; this implies a thick/strong interface between polyurea-2 particles and epoxy, corresponding to the TEM analysis discussed above.

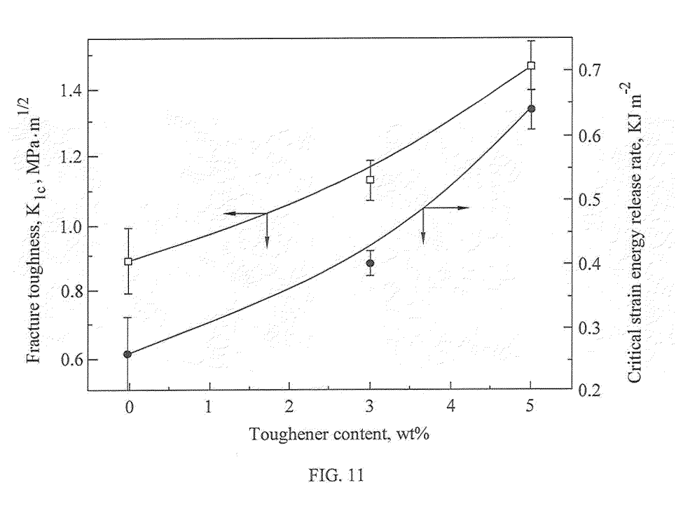

The effect of the polyurea-2 on the fracture toughness (K_{1c}) and the energy release rate (G_{1c}) is shown in FIG. 11. Both K_{1c} and G_{1c} increase obviously with increasing the polyurea-2 fraction. A content of 5 wt % of the polyurea-2 significantly enhances the energy release rate from 0.26 to 0.64 kJ m⁻², a 146% improvement.

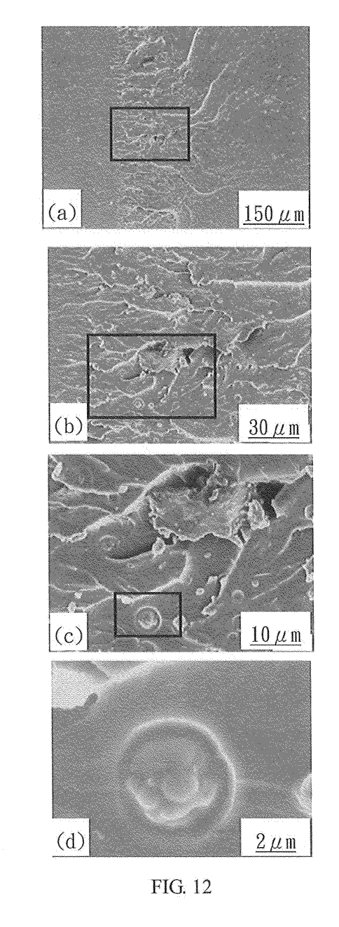

Fracture surface analysis by SEM: FIG. 12 shows SEM micrographs of the surface of a fractured CT specimen of the epoxy composite containing 5 wt % of the polyurea-2 (denoted as the epoxy/polyurea-2 composite), with crack propagating from left to right. The propagation zone in FIG. 12(a) shows a rough surface with a great many deformation lines. A number of representative deformation lines observed are magnified in FIG. 12(b). The deformation lines are actually bridged or deflected cracks. The middle zone (marked with a rectangle) magnified in FIG. 12(c) shows scale-like structure with bands and particles of 3-10 μm in diameter. While most particles are particulate and featureless, some particles show multiphase structure, one of which is further magnified in FIG. 12(d). The particle has a ‘salami’-type structure similar to that in the epoxy/polyurea-1 composite. Similar to the polyurea-1, the polyurea-2 reacts with the epoxy during mixing, leading to a strong interface of the particles to be formed during subsequent curing. However, the polyurea-2 is stiffer, as it increases both tensile strength and Young's modulus of the epoxy. Under loading, either the interface or the surrounding matrix deforms first, depending on the interface debonding strength; particles experience less of a degree of deformation. If the interface deforms first, particle debonding would be observed in FIG. 12. However, no debonding is actually observed. This implies that matrix deformation in the form of bands, scales and cracks is the main fracture phenomenon. In the foregoing discussion, energy dissipation in the epoxy/polyurea-1 composite occurs in both matrix and particles. By contrast, energy dissipation in the epoxy/polyurea-2 composite most likely focuses on matrix deformation. Therefore, a greater number of and more obvious deformation lines should appear on the surface of fractured CT specimens of the epoxy/polyurea-2 composite than of the epoxy/polyurea-1 composite. A comparison of FIG. 12 with FIG. 7 supports this deduction.

Thermal properties of epoxy and its composites: Dynamic mechanical thermal analysis (DMTA) is a technique that measures the properties of materials as they are deformed under periodic stress. Specifically, a variable sinusoidal stress is applied, and the resultant sinusoidal strain is measured in DMTA. The phase difference between the stress and strain sine waves is expressed as tan δ, and the peak values of tan δ correspond to the glass transition temperatures (Tg) of the polymers being analysed. As 5 wt % of toughener does not show a separate glass transition, the investigation is conducted from 30 to 110° C.

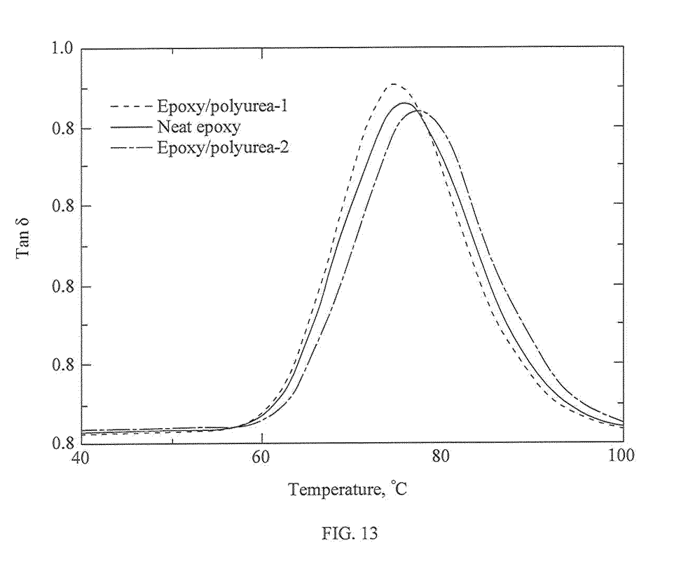

FIG. 13 shows the tan δ—temperature patterns of neat epoxy, the epoxy/polyurea-1 composite, and the epoxy/polyurea-2 composite. From data analysis, Tg values of neat epoxy, the epoxy/polyurea-1 composite and the epoxy/polyurea-2 composite are 74.6, 75.6 and 77.4° C., respectively. As discussed above, the polyurea-2 stiffens and strengthens the epoxy and thus is stiffer and stronger than the polyurea-1. Tg is the temperature at which the segments of molecular chains start moving. At the testing temperature of ca 75° C., the polyurea-1 particles soften the epoxy matrix, promoting the motion of chain segments. This reduces Tg. By contrast, the polyurea-2 particles stiffen the epoxy matrix, hindering the motion of chain segments, and thus increasing Tg.

Therefore, according to as described above, the following novel tougheners were developed for epoxy:

(1) The polyurea-1, which was synthesized from IPDI and Jeff-D2000, formed micrometre-sized particles with a thick interface through mixing and curing with epoxy. A content of 5 wt % of the polyurea-1 enhanced the fracture energy release rate from 0.26 to 0.95 kJm⁻² and, more importantly, caused no loss of other desirable properties. The polyurea-1 reduced slightly the glass transition temperature of the epoxy.

(2) The polyurea-2, which was synthesized from IPDI and Jeff-D400, formed both micrometre-sized particles and nanoparticles through mixing and curing with epoxy. A content of 5 wt % of the polyurea-2 enhanced the fracture energy release rate from 0.26 to 0.64 kJ m² and also increased Young's modulus and tensile strength. The polyurea-2 increased the glass transition temperature of the epoxy.

### Example 2

### Synthesis of Epoxy/Polyurea Composites with Different Reaction Time

Polyurea, synthesized from Jeff-D2000 and IPDI as described in Example 14, was mechanically mixed with a desired amount of epoxy resin, diglycidyl ether of bisphenal A (DGEBA, Araldite-F) with an epoxide equivalent weight 182-196 g/eq. (denoted as epoxy), in a beaker at 80° C. for 20 minutes to evaporate the acetone. In order to investigate the effect of reaction time on the morphology and toughness of the epoxy resin/polyurea composite, three batches of the solution comprising the polyurea and DGEBA had been mixed for 5, 20 and 35 minutes at 120° C., respectively, before hardener piperidiene (5 g for 100 g epoxy) was added. The blend was then degassed, poured into different moulds and followed by curing at 120° C. for 17.5 h.

Gel Permeation Chromatography (GPC)

A Waters chromatograph system with a 510 HPLC pump was used to measure the molecular weight of polyurea, with a mixed-bed Styragel/HT 6E column and a high-purity THF eluent at a flow rate of 0.8 ml/min. Eluted fractions were detected with a 8401 differential refractometer. Solutions for GPC were also made up in THF.

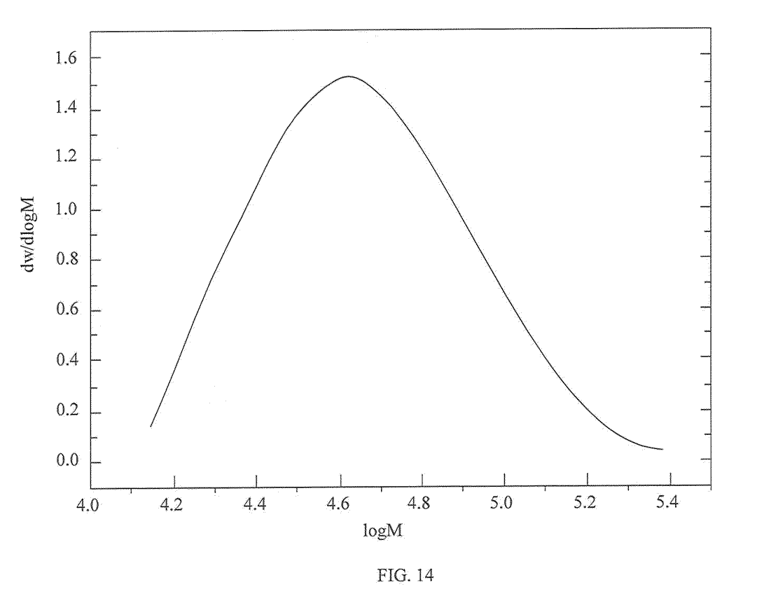

Weight average molecular weight (Mw) and Number-average molecular weight (Mn) of the synthesized polyurea are 5.1×10⁴ g/mol and 3.7×10⁴ g/mol, respectively, with Molecular weight distribution 1.4. The molecular weight distribution graphically shown in FIG. 14 is typical for polycondensation.

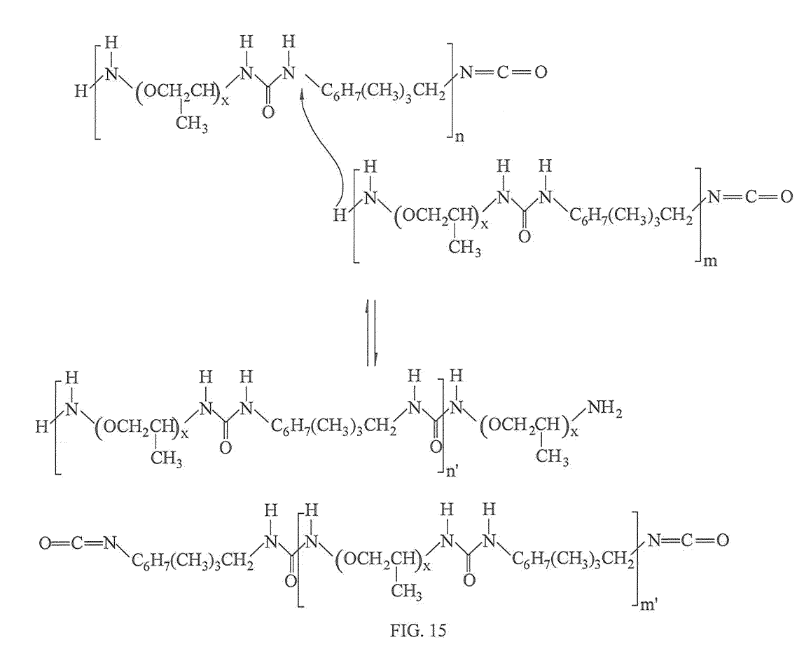

During polymerization, the polyurea molecular weight increases continuously with a great number of intermediates formed in independent, individual reactions. These intermediates are oligomeric and polymeric molecules with the same functional end groups (amine and isocyanate) as the starting reactants. Finally the polymerization reaches a state of dynamic polymerization equilibrium in which the rates of formation and consumption of molecules of a given degree of polymerization are equal. The equilibrium is featured by exchange reactions which occur between free end groups and junction points in the chain as shown in FIG. 15. The exchange reactions alter neither the number of free functional groups, nor the number of molecules, nor the number-average degree of polymerization. Upon adding a new reactive component into the reactions, however, the equilibrium breaks and moves towards either higher or lower molecular weight, depending on the molecular weight of the new component.

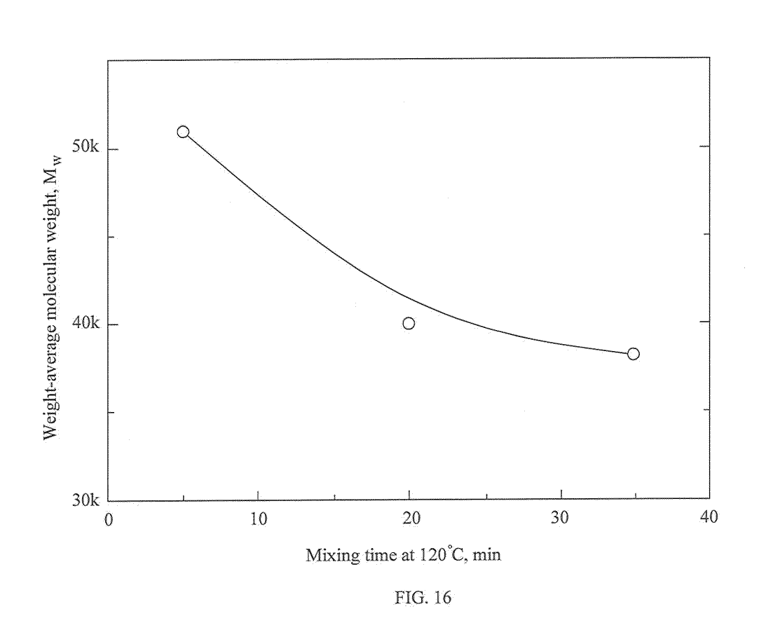

As described above, the three batches of epoxy solutions containing 2-10 wt %, preferably 5 wt %, polyurea were mixed for 5, 20 and 35 minutes at 120° C., respectively, to investigate the effect of reaction time on the morphology and toughness of the composites. In this embodiment, the polyurea content 5 wt % is low in comparison with the epoxy content 95 wt %; that is, polyurea acts as a solute and epoxy is actually the solvent. The following chemical reactions may occur during mixing: (a) reaction between the amine group (—NH) and the epoxide group, and (b) reaction between the isocyanate group (—NCO) and the hydroxyl group (—OH) of epoxy. A question to ask is whether these reactions change the molecular weight of polyurea and the morphologies and fracture toughness of the composite. As aforementioned, the equilibrium would break and moves as long as a new reactive component added. The exchange reactions provide the unlimited source of end groups (NH₂ and NCO) of polyurea, which subsequently reacted with epoxy molecules. Because of the excessive quantity 95 wt % of low molecular weight epoxy (˜400 g/mol), it is expected that upon mixing with epoxy, the polyurea equilibrium would move to low molecular weight due to these reactions. The three batches of the epoxy/polyurea mixed for various time were measured by GPC. In FIG. 16, Mw decreases from 5.1×10⁴ to 3.7×10⁴ with prolonging mixing by 30 minutes, and this indicates that epoxy reacted with polyurea, causing the reduction of the molecular weight.

Fourier Transform Infrared Spectroscopy (FT-IR)

FT-IR spectra of epoxy and various epoxy/polyurea specimens were recorded between 4000-400 cm⁻¹ on a Nicolet Avatar 320 FT-IR spectrometer. FT-IR specimens were prepared by the solution-casting method on the KBr plate. A minimum of 32 scans was signal-averaged with a resolution of 2 cm⁻¹.

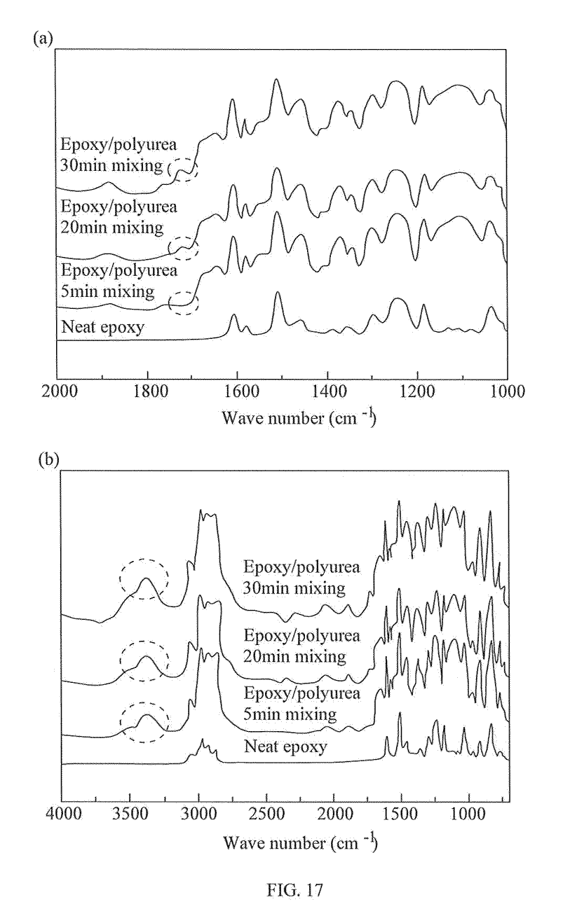

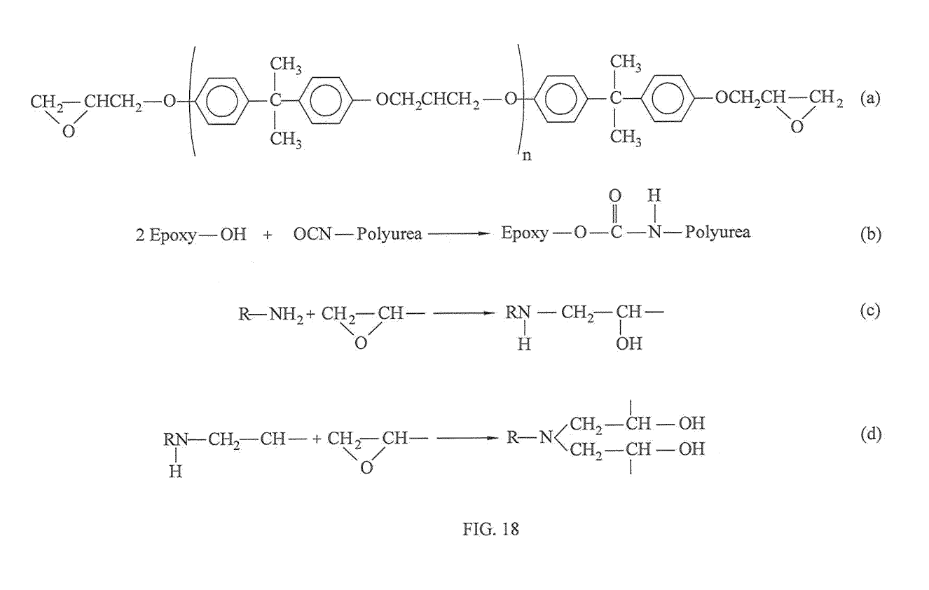

The aforementioned chemical reactions were to be supported by FT-IR characterization of neat epoxy and epoxy/polyurea solutions mixed for different time. Upon reaction, new or more intensive absorption peaks would appear. FIG. 17 shows FT-IR spectrums of neat epoxy and the epoxy/polyurea composite solutions mixed for different time. In FIG. 17(a), absorption at 1725 cm⁻¹ increases significantly with mixing time, and it is caused by the formation of C═O clue to the reaction between the isocyanate group (—NCO) and the hydroxyl group (—OH) of epoxy. In FIG. 17(b), absorption at 3380 cm⁻¹ increases significantly with the mixing time, caused by the formation of NH due to the reaction between the amine group (—NH) and the epoxide group. Both reactions are shown in FIG. 18. Noteworthy is that the reaction between the isocyanate group (—NCO) and the hydroxyl group (—OH) is a valuable method for modification of tougheners. The reacted molecules play a critical role in this system for the following functions: (a) it increases the particle weight fraction, which thus improves the toughness; and (b) it acts as a compatibiliser, improving the interfacial adhesion. Due to phase separation in curing, the reacted epoxy/polyurea molecules form nanoparticles. As discussed below, these nanoparticles are either dispersed in the matrix, or located at the interface of dispersed particles, or anchored into the particles.

Electron Microscopy Analyses

Ultra-thin sections 50 to 60 nm in thickness were cryogenically microtomed with a diamond knife in liquid nitrogen at −120° C. using a microtome. Sections were collected on 400-mesh copper grids and stained by the vapor of a 1 wt % ruthenium tetroxide (RuO₄) water solution for 8 minutes to enhance the phase contrast between particle and epoxy. Subsequently, thin sections were examined using a transmission electron microscope (TEM) at an accelerating voltage of 120 kV.

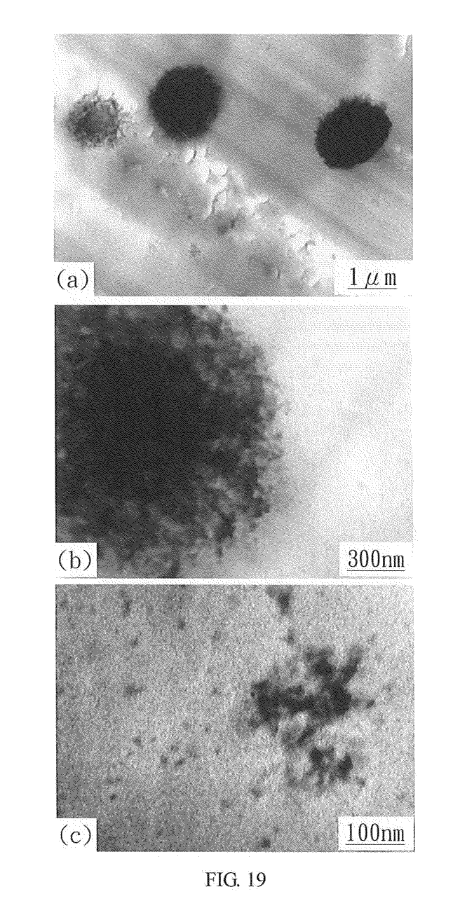

TEM was employed to study the effect of mixing time on the morphology of the cured epoxy/polyurea composites. All cryo-sections were stained by the same procedure as described above. The polyurea consists of flexible Jeffamine segments and stiff diisocyanate segments. The flexible Jeffamine segments are more readily stained and thus appear darker under TEM. FIG. 19 shows TEM microphotographs of the epoxy/polyurea composite mixed at 120° C. for 5 minutes before curing. Particles of 1-2 μm in diameter are displayed in FIG. 19(a); the contrast between particles and matrix is strong; each particle has a blurred interface with the matrix. At a high magnification in FIG. 19(b), it is seen that each particle is actually an aggregate of many nanoparticles. In FIG. 19(c), a few nano-particles form a cluster, while others are evenly dispersed in the matrix. The parallel lines in these images are caused by microtoming.

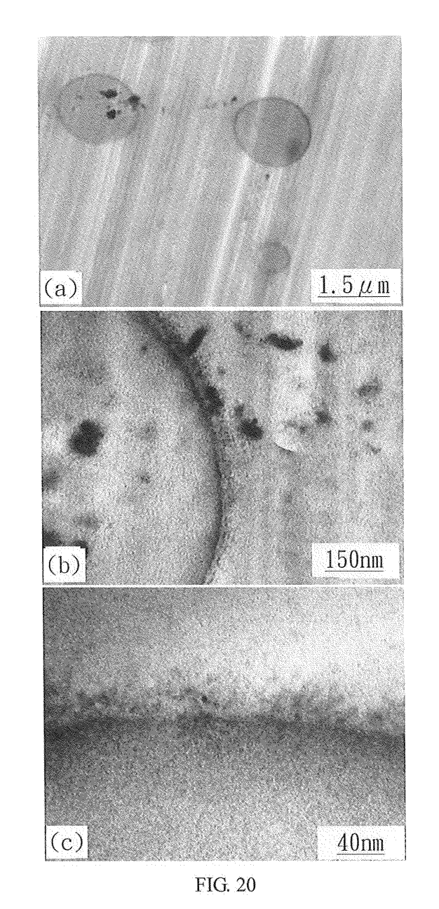

FIG. 20 shows TEM microphotographs of the epoxy/polyurea composite with 20-minutes of mixing time. Compared to FIG. 19(a), these particles have lower contrast; some particles are only partially stained in FIG. 20(a). At a higher magnification in FIG. 20(b), some nanoparticles are found inside the micro-particles, at the interface and within the matrix. The interface of a typical micro-particle, magnified in FIG. 20(c), is in fact composed of many nanoparticles.

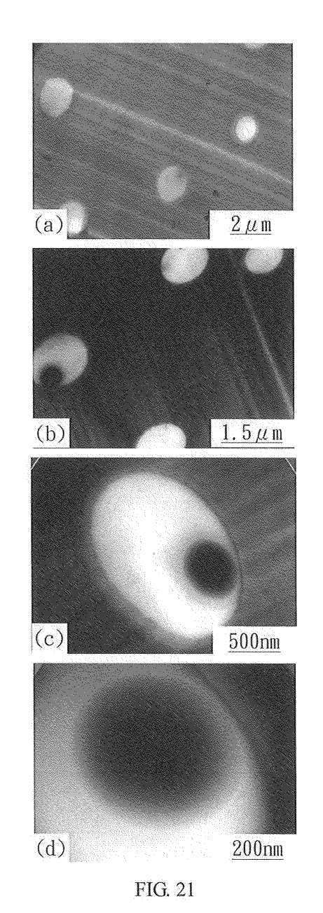

FIG. 21 shows TEM microphotographs of the epoxy/polyurea composite with 35-minutes mixing time. FIGS. 21(a) and 21(b) belong to different sections, which show that the particle color is even lighter than epoxy, as opposed to FIG. 19(a). This indicates that the susceptibility of the particles for staining is reduced with increasing the mixing time. The quantity of nanoparticles dispersed in the matrix is also decreased. Many micro-particles have multi-layered structure. FIG. 21(c) shows a particle with a three-layer structure: a dark core, a large white shell and a grey outer shell of 100-200 nm. The dark core magnified in FIG. 21(d) appears to be graded. The effect of the mixing time on the morphology of epoxy/polyurea composite is generalized as that, with increasing the mixing time, the particles become less stainable, the interface thickness increases, and the amount of nanoparticles dispersed in the matrix reduces. This is due to the reactions occurred between epoxy and polyurea during the mixing at 120° C. As the matrix was cured during crosslinking, the reacted polyurea/epoxy molecules aggregated to form particles which inevitably embedded an amount of epoxy molecules. The exchange reactions of polyurea continue to proceed within particles and provided epoxy molecules with reactive end groups including NCO and NH₂. Thus, the reactions of polyurea with epoxy led to high crosslink density of the particles and thick interface. The longer polyurea/epoxy mixed before curing, the higher degree the crosslink density, corresponding higher resistance to the staining agent. As a result, the particles of longer mixing time are less stainable.

Fracture Toughness Tests

The Compact-Tension (CT) specimens were cured in the mold and then both side's were polished by an emery paper until all visible marks disappeared. An instantly propagated crack was introduced by razor tapping. Six specimens were tested for each data set with a crosshead speed of 0.5 mm/min. Fracture toughness K_{1c} and G_{1c} values of CT specimens were calculated using maximum loads and validated according to ISO 13586.

Fracture toughness is the most important material property for brittle resins, upon which the mixing time has an obvious effect in the present invention. With increasing the mixing time, in Table 1, the toughness increases from 1.39 to 1.98 MPa·m^{1/2} without loss of Young's modulus, demonstrating the advantage of the reaction between a toughener and matrix. Given the deviation values, the mixing time has no effect on Modulus. The obvious toughening effect was causes by the reactions between epoxy and polyurea, which increase the particle weight fraction and the particle/matrix interface strength.

TABLE 1
Mechanical properties and toughness of
epoxy/polyurea composites (5 wt %).

| | | Epoxy/ | Epoxy/ | Epoxy/ |
|---|---|---|---|---|
| | Neat | polyurea, | polyurea, | polyurea, |
| Materials | epoxy | 5 mins | 20 mins | 35 mins |
| Fracture | 0.78 ± 0.02 | 1.39 ± 0.03 | 1.75 ± 0.02 | 1.98 ± 0.02 |
| toughness, K_{1c}, | | | | |
| MPa · m^{1/2} | | | | |
| Young's | 2.89 ± 0.13 | 2.84 ± 0.09 | 2.91 ± 0.14 | 2.86 ± 0.11 |
| Modulus, GPa | | | | |

In this embodiment, piperidine-cured epoxy was significantly toughened by a reactive polymer-polyurea. As elaborated by FT-IR, the reactions combined epoxy molecules with polyurea, leading to higher particle concentration and thicker interface and thus higher toughness. GPC measurement shows that the reactions reduced the molecular weight of polyurea. TEM observation demonstrates thick interface of the particles due to these reactions, which strengthened load transfer and thus contributed to high fracture toughness. It was found that the particles became less stainable with prolonging the mixing time, as longer time produced more reaction sites for crosslinking. When the mixing time prolonged from 5 minutes to 35 minutes, the fracture toughness improved from 1.39 to 1.98 MPa·m^{1/2}.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A method of toughening epoxy resin, comprising a step of:
mixing an epoxy resin with a toughener selected from the group consisting of polyurea, polyurethane and poly(urea-urethane) for a predetermined period of time at a predetermined temperature,
wherein an amine group of the toughener is reacted with an epoxide group of the epoxy resin, or an isocyanate group of the toughener is reacted with a hydroxyl group of the epoxy resin to form a modified epoxy resin.

2. The method of toughening epoxy resin of claim 1, wherein the toughener is present in an amount of about 1 to about 10% by weight.

3. The method of toughening epoxy resin of claim 1, wherein the toughener is present in an amount of about 5% by weight.

4. The method of toughening epoxy resin of claim 1, wherein the polyurea is synthesized by a stepwise addition polymerization reaction of diamines and diisocyanates.

5. The method of toughening epoxy resin of claim 4, wherein the diamines comprises polyoxyalkyleneamine, and the diisocyanates comprises diphenylmethane diisocyanate (MDI), toluene diisocyanate (TDI), hexamethylene diisocyanate (HDI) or isophorone diisocyanate (IPDI).

6. The method of toughening epoxy resin of claim 5, wherein weight-average molecular weight of the polyurea is in a range of 200 to 60000.

7. The method of toughening epoxy resin of claim 1, wherein the epoxy resin comprises diglycidyl ether of bisphenal A (DGEBA) or diglycidyl ether of bisphenal F (DGEBF).

8. The method of toughening epoxy resin of claim 1, wherein the predetermined period of time is in a range of about 1 to about 60 minutes.

9. The method of toughening epoxy resin of claim 1, further comprising a step of adding a hardener to cure the epoxy resin.

10. The method of toughening epoxy resin of claim 9, wherein the toughener forms nanoparticles or micrometre-sized particles.

11. The method of toughening epoxy resin of claim 10, wherein the nanoparticles are dispersed in the epoxy resin, located at an interface of the dispersed micrometre-sized particles, or anchored into the micrometre-sized particles.

12. A toughened epoxy resin composite, comprising an epoxy resin and a toughener selected from the group consisting of polyurea, polyurethane and poly(urea-urethane).

13. The toughened epoxy resin composite of claim 12, wherein the toughener is present in an amount of about 1 to about 10% by weight.

14. The toughened epoxy resin composite of claim 12, wherein the toughener is present in an amount of about 5% by weight.

15. The toughened epoxy resin composite of claim 12, wherein the epoxy resin comprises diglycidyl ether of bisphenal A (DGEBA) or diglycidyl ether of bisphenal F (DGEBF).

16. The toughened epoxy resin composite of claim 12, wherein weight-average molecular weight of the polyurea is in a range of 200 to 60000.

17. The toughened epoxy resin composite of claim 12, further comprising a hardener.

18. The toughened epoxy resin composite of claim 17, wherein the hardener is present in an amount of about 5-25% by weight.

19. The toughened epoxy resin composite of claim 17, wherein the toughener is in a form of nanoparticles or micrometre-sized particles.

20. The toughened epoxy resin composite of claim 19, wherein the nanoparticles are dispersed in the epoxy resin, located at an interface of the dispersed micrometre-sized particles, or anchored into the micrometre-sized particles.
